(19) United States
(12) Patent Application Publication
(10) Pub. No.: US 2013/0166697 A1
(43) Pub. Date: Jun. 27, 2013

(54) MULTICONFIGURATION DEVICE CLOUD ENTITY PROTOCOL

(71) Applicant: Gregory P. Manning, New York, NY (US)

(72) Inventor: Gregory P. Manning, New York, NY (US)

(21) Appl. No.: 13/725,643

(22) Filed: Dec. 21, 2012

Related U.S. Application Data
(60) Provisional application No. 61/579,565, filed on Dec. 22, 2011.

(51) Int. Cl. H04L 29/06

(52) U.S. Cl. CPC H04L 29/06163
USPC 709/219

(57) ABSTRACT

Disclosed is a system and computer based method that optimize transmission of content streams to multiconfiguration devices. In a preferred embodiment, network bandwidth usage is optimized while maximizing the efficient distribution of content and computing services to serve all persistent device states of a multiconfiguration device. In certain embodiments, disclosed are systems and methods which provide for increased efficiencies between multiconfiguration devices or multiconfiguration device arrays.

### PRIORITY CLAIM

The present application claims priority to U.S. Provisional Application No. 61/579,565 filed Dec. 22, 2011, the contents of which are herein incorporated by reference.

### FIELD OF THE INVENTION

The present application relates to digital interfaces for mobile devices and digital device entities, and computer languages and transmission protocols to support communication between digital devices and digital entities across wired and wireless networks.

### BACKGROUND

Mobile devices have typically maintained a single digital device identity throughout their functional life, with functional capabilities integrated into the device's physical form. The user interface consists of a single initial set of input modes and graphic user interface (“GUI”), video and audio capabilities. Varied data and content streams similarly are interacted with or manipulated thorough a single, native GUI and functional and interface capabilities. Such devices may be seen as single configuration devices (“SCDs”).

A multiconfiguration device (“MCD”) may be configured in at least two different physical forms, each form associated with a different device state, and each device state comparable or analogous to the device states of similarly conformed SCDs. Preferably, the MCD may maintain the full set of functional and interface capabilities embodied in all of its potential device states simultaneously, with performance equal or superior to benchmark performance standards for such devices as SCDs. MCDs may have detachable components that may be used either as contiguous components or as detached components remaining in contact through a wired or wireless connection. In one form of digital convergence, devices may provide more than one functional state, while maintaining a single physical form. For example, a mobile device with one physical form that is between the size of a tablet and a phone, and provides the function of both a tablet and phone, may be considered a convergent or converged device. As used herein, the term MCD includes the use of such convergent devices within a broader category of convergence devices that includes devices that may be reconfigurable into more than one physical form, where one or more of those physical forms is also capable of providing more than one functional state.

MCDs may also be used in arrays of at least two MCDs, permitting those at least two MCDs to realize additional potential variable states that exceed the variability of the individual MCDs that are members of the array. Similar benefits are realized when SCDs are configured in an array, thereby creating a pseudo-MCD with the second, converged state of the devices being an array of two or more connected SCDs. For purposes of this specification, it is understood that the terms “array of MCDs” and “MCD array” includes an array of SCDs. An array of MCDs may fluctuate between potential aggregate device identities and capabilities across a variable range of potential states with variable periodic frequency, including aggregate identities and capabilities that may offer or bring efficiencies that enhance or exceed previously known functional or processing capabilities. Device arrays and other features relevant to the present application are disclosed in U.S. Pat. No. 7,782,274 filed Jun. 9, 2006 to the present applicant, which is herein incorporated by reference in its entirety.

Current computer languages and communications protocols are not designed to serve such MCDs or MCD arrays with fluctuating device identities linked to multiple potential configurations and device sessions over random periodic frequencies. Under existing computer languages and communications protocols each of the persistent states within an MCD may be required to receive and transmit information as a separate device entity, which may prevent MCDs and MCD arrays from realizing efficiencies through shared transmission resources, while failing also to reduce bandwidth requirements on networks and the Internet by optimizing information flow according to fluctuating but individuated device identities. Accordingly, there is a need for methods and systems for providing computer languages, processing and communications protocols that will optimize the operation of MCDs and MCD arrays and provide for the recognition and recording of technical efficiencies and capabilities that exceed previous performance benchmarks.

### BRIEF DESCRIPTION OF THE DRAWINGS

FIG. 1 is a high-level schematic of SCDs/MCDs/MCD arrays interfacing with cloud repositories, in accordance with certain embodiments of the present invention.

FIG. 2 is a local cloud, in accordance with certain embodiments of the present invention.

FIG. 3 illustrates an embodiment of protocol operation, in accordance with certain embodiments of the present invention.

FIG. 4 lists example MCD capabilities, in accordance with certain embodiments of the present invention.

FIG. 5 depicts a block diagram of the architecture of a multiconfiguration device, in accordance with certain embodiments of the present invention.

FIG. 6 represents high-level architecture of the present invention, in accordance with certain embodiments.

FIG. 7 represents a process flow of the present invention, in accordance with certain embodiments.

FIG. 8 represents a process flow of the present invention, in accordance with certain embodiments.

FIG. 9 represents a process flow of the present invention, in accordance with certain embodiments.

### DETAILED DESCRIPTION OF THE INVENTION

The present application therefore provides methods and systems that optimize transmission of content streams and digital databases, computing, and processing services to MCDs, optimizing network bandwidth usage while maximizing the efficient distribution of content and computing services to serve all persistent device states within fluctuating but individuated identities and configurations of MCDs and MCD arrays, and between MCDs and MCD arrays and digital communications and computing networks. The present application also provides methods and systems to serve MCDs or MCD arrays and to recognize or record increased efficiencies or spontaneous instances of technical novelty that result from the random interaction of variable device identities and capabilities across an exponentially expanding incidence of inherently random device interactions.

Such methods and systems may form the basis for new operating systems, computer languages, transfer protocols, and network architectures to support MCDs, including log files and historical repositories of log files recording all transmission, actions, combinations of device states and capabilities. Such comprehensive log file repositories may be seen as databases offering historical innovation evolution telemetry for the MCDs and cloud-based communications and computing services, offering a more thorough monitoring of digital events and their solutions across all networks that may permit more extensive and more effective discovery and distribution of solutions or responses to monitored events.

In one embodiment, the system always performs the logging function, and there is no ability for a user to opt-out of such logging and log storage. These logs, however, are encrypted in order to preserve the user's discretionary control with respect to privacy regarding their usage and system architecture, and so they must be unlocked or decrypted before the data may be utilized. Such embedded constant logging function may have the benefit of ensuring that such log databases regarding digital device usage are substantially complete across the universe of device usage, permitting retrospective access to data underlying performance metrics or functional problems that are not as yet identified as worthy of study or remedy, but may be so identified at a future date.

Such methods and systems may employ enhanced digital security technologies, including intra-MCD encryption and use of biometric security protocols. In one embodiment such digital security technologies may also general duplicate encrypted logs that may be purposed for use by law enforcement agencies as limited by laws governing law enforcement and government agency access to and permitted law enforcement and government agency use of private information.

In one embodiment of the present invention, multiple data stream requisitions are continually conformed to the continually varying demands of MCDs, which process varied data and content streams through multiple native sets of functional and interface capabilities utilizing independent central processing units (CPUs) or CPU cores, and provide user interfaces through multiple native sets of graphic and video display and audio functional capabilities, input and output modes. MCDs may maintain any of one, two, or n persistent device states simultaneously, depending on the default settings for the device or the settings as customized by the user, such that the device's macro-identity may change between variable functions and variable device states with variable periodic frequency. Upstream conforming of the information required to serve such fluctuating device and functional identities may equip the MCD to function more efficiently and may serve to optimize bandwidth on wired and wireless networks.

In another embodiment, network registration protocols may permit a single MCD to efficiently make multiple network registrations simultaneously, rather than sequentially, recognizing the varying persistence and priority of device states within the MCD, according to any of the physical configuration of the MCD, or defaults as set by the manufacturer or modified by the user. In this embodiment an MCD opened as a phone will prioritize the display of content related to telephony and messaging, as well as retrieve content relevant to sessions as a laptop, e-reader, tablet, or digital video, depending on user preferences. The same MCD opened as a tablet e-reader will prioritize the display of content related to tablet or e-reader usage, while retrieving content relevant to telephony, messaging, and digital video, or may prioritize digital video if the MCD is configured as a flat screen television. All device states may be registered with the network, or some subset of device states as chosen by the user.

Object Oriented Programming (OOP) defines objects and data classes and the logic that may be used to manipulate them, using data subclasses as delimited building blocks to expedite software development and to minimize data corruption, as the data subclasses are known and do not require a periodically variable description. Programmers use messages to interact with these software objects, which in turn interact with each other according to their known characteristics. The stability at the object level of OOP may aid in serving the functional capabilities in persistent devices states within an MCD, but may be unsuited to managing the operation of MCDs or their interactions with wired or wireless networks.

Individuated MCDs may be considered as objects that are inherently unstable, and for which no data statements or logic manipulations may be fixed. In one embodiment provision may be made for an MCD environment where the potential functional capabilities and configurations of an MCD may be known with reasonable certainty, but the active capabilities, the priority relationships between them, the persistent device states being maintained, and the MCDs' current physical configuration cannot be known in advance. In this embodiment information delivery to MCD identities with multiple persistent states and multiple variable device sessions may be optimized to permit efficient communication and computing with and among MCDs through all potential combinations of persistent device states and identities while optimizing bandwidth and operational efficiencies locally and upstream throughout the digital communications network, including cloud computing services. Individual MCDs and MCD arrays may not be required to function as ad hoc groupings of devices, but may be equipped to function as coherent units configurable into multiple physical conformations bringing significant operational efficiencies including parallel processing capabilities, with optimization intrinsic to the MCD and through leveraging upstream processing and communications resources.

In another embodiment, network registration and communication of MCD arrays of at least two MCDs may perform all the inventory and retrieval functions of individual MCD registrations, while also permitting those at least two MCDs to recognize additional potential variable states and capabilities including potential efficiencies from parallel processing to maximize the efficiencies intrinsic to the aggregate capabilities of the MCD array. In this embodiment network communications and protocols may log network performance and communications metrics to efficaciously serve individual MCDs and MCD arrays with at least the same efficiency as SCDs are currently served.

In this embodiment the network may log events as such MCD arrays fluctuate between potential aggregate device identities and capabilities across a wide variable range and variable periodic frequency. The range of performance encountered in such MCD arrays may encompass both inefficiencies as well as heretofore unknown or unstudied conformations and/or configurations of aggregate identities and/or capabilities that may extend technological boundaries, and may be seen as spontaneous technology innovation. In this embodiment the network communication protocols may beneficially record increased efficiencies or spontaneous instances of technical novelty that result from the random interaction of variable device identities in their varied configurations and varied persistent states, and efficiencies that result from optimizing of combined capabilities through an exponentially expanding incidence of inherently random device interactions as more MCD devices are used individually and in arrays. Such spontaneous instances of technical novelty may therefore be recorded through a continual innovation evolution telemetry function so that they may be studied or replicated. Forms of interaction and communication may include applications, games and gaming applications, mobile payment and mobile payment applications.

In another embodiment the provisions made for functional and processing capability assessment may be equally beneficial to MCDs sharing resources on a network with SCDs as well as other devices with digital capabilities, such that the network and communication protocols may initially and continually inventory functional, processing, and communications capabilities available on the network, as well as logging events and identifying efficiencies that may optimize operation and may exceed previously measured benchmarks for the local network, larger networks, or overall standard benchmarks for device classes.

There may be swapping or sharing of CPU resources for certain CPU-intensive activities. In one embodiment, local clouds may have the functional goal of more efficiently accomplishing complex tasks or CPU-intensive tasks. In this embodiment the combination of CPU resources in a flexible pattern of hierarchies may permit more intensive focus by aggregated multiple CPUs on tasks that may effectively leverage parallel processing efficiencies. In one embodiment the functional goal is an explicit statement, set of instructions, or programming commands and which if such explicit articulation is made may be defined as the array's “Functional Goal” (“FG”).

Within an MCD array, certain CPUs may be assigned supervisory roles in the array's functional operation, establishing a temporary hierarchy with and among other CPUs in the array that may have the same processing and computing capability and beneficially assume subordinate roles in fulfilling the array's functional goal. There may be provisions for the CPU of a designated supervisory device to guide the operations of subordinate CPUs for purposes of function delivery. In certain embodiments, instead of or in addition to a hardware based supervisory CPU, a “HYPERVISOR”¹ system may be used.

In one embodiment, an MCD array may be created where at least two MCDs have been combined to create an incrementally larger HD television display. In such an embodiment, one supervisory CPU may retrieve video content for display, while the at least one subordinate CPU may solely receive data pertaining to the act of displaying the video content. In such an embodiment, the form of the MCD array may be seen as dictating the MCD array's function as well as optimizing the efficiency of the MCD array's operation by assigning a subordinate operational role to at least one subordinate CPU. ¹ In computing, a hypervisor or virtual machine manager (VMM) is a piece of computer software, firmware or hardware that creates and runs virtual machines. A computer on which a hypervisor is running one or more virtual machines is a host machine. Each of those virtual machines is called a guest machine. The hypervisor presents to the guest operating systems a virtual operating platform and manages the execution of the guest operating systems. Multiple instances of a variety of operating systems may share the virtualized hardware resources.

In a similar embodiment MCDs may be combined in array to cover floor, walls, and ceiling in a room to provide for a total virtual reality environment, with a single supervisory CPU, or tiers of CPUs supervising display. In this embodiment users may leverage many forms of interface possibilities with the MCD array to interface with the virtual reality environment, including motion detection, voice, selected touch events excluding or including footsteps, proximity detection, or any other means of interface.

In another embodiment, the form of the MCD array may be dictated by the functional goal for the MCD array. For example, in one embodiment it may be desired to take either still or video images of a particular object from multiple angles in a synchronized manner. In this example, the MCD array may be assembled in a trifold shape, or any other desired shape, to take synchronized images of a common object for descriptive, analytical, or other purposes. In this embodiment the supervisory CPU would control the photographic operation of the other members of the array, including digital time synching of the still or video images. In a similar embodiment it may be desired to photograph a 360 degree surrounding area, whereby the MCD array would take the form of an outward facing core of cameras supervised again by one supervisory CPU operating all cameras within the array. In another embodiment an MCD array may be purposed for the recording of a 360 spherical surrounding area, in order to serve, for example, the creation of total virtual reality environments. In these examples, function may be seen as having dictated form.

In another embodiment individual MCDs may be physically reconfigured so that multiple onboard cameras may perform analogous or the same functions with similar relative positions to the other cameras on the MCD, and similarly record the still or video images in a digitally synchronized manner, without need for an MCD array. It may be seen that in the previous embodiments, the MCD array may have performed the similar operation on a larger scale. An MCD array may have been required to accomplish the functional goal because an individual MCD was not of sufficient size to perform the task, or did not have sufficient components.

In another embodiment, one member of an MCD array may receive electrical power and share it with other members of the array, permitting the multiple components of the MCD array to remain powered and to replenish the power reserves in their batteries. One beneficial consequence of this capability is that only one interface with an electrical power supply may be necessary to charge multiple MCDs.

It should be noted that the above examples pertain to the display or recording of still or video images in various ways, and that in certain embodiments form dictated function, while in others, function dictated form. It should also be noted that innovative forms of arrays may be created with innovative functions, and that such events would be logged. Form may follow function, in a sense, but new forms may also be created with entirely new functions that were heretofore undiscovered, but which have been beneficially recorded.

SCDs typically conform to a fixed configuration mode, in a single physical unit, and a single persistent device state with a fixed functional set of native processing capacity, interfaces and output modes. SCDs may have a simple Mobile Identity (“MI”) expressed as MI.A.1, where “A” denotes a single functional set and “1” denotes a single fixed physical conformation. As a term, SCD may be viewed as synonymous with “Quantum Digital Identity,” which may describe SCD functional sets that serve as the quantum core components of MCDs, and which in aggregate may serve to form an MCD's more complex MI. MCDs may have multiple physical conformations and persistent states, and are thus capable of a multiplicity of MIs.

The identity of an MCD that does not have a detachable component may be expressed as MI.B.1.0.1, 2, 3 . . . n,” where “B” may denote an MCD, “1” may denote a single physical unit, “0” may denote no detachable components, and “1, 2, 3 . . . n” may be descriptive of the MCD's current physical conformation. The identity of an MCD where a component is detachable may be expressed as “MI.B.2.1.c1, c2, c3 . . . cn.d1, d2, d3 . . . dz” where “B” may denote an MCD, “2” may denote the presence of detachable components, “1” may denote that the MCD is currently being used with no components detached, “c1, c2, c3 . . . cn” may be descriptive of the MCD's current physical conformation, and “d1, d2, d3 . . . dz” may be descriptive of the priority persistent device state. In such MIs expressed as “MI.B.2.1 . . . etc.” components that may be unhooked from the MCD but remain physically wired to the MCD may be identified by the physical conformation code, rather than being identified as detached. An MCD being used with at least one component physically detached and not physically wired to the MCD may be expressed as “MI.B.2.2.c1, c2, c3 . . . cn.d1, d2, d3 . . . dz” where “B” may denote an MCD, “2” may denote the presence of detachable components, “2” may denote that the MCD is currently being used with wireless bridges to detached components, “c1, c2, c3 . . . cn” may be descriptive of the MCD's current physical conformation including the detached physical components, and “d1, d2, d3 . . . dz” may be descriptive of the priority persistent device state.

Many combinations of physical conformations and of persistent device states will be available to each MCD, and this notation is but one example of how the many facets of an MCD's current MI may be indicated. In one embodiment additional identifiers may be used to indicate all persistent device states in order of priority. Alternatively, the priority of content requisitions may be utilized as a means to indicate the priority persistent device state. It should be noted that all persistent device states will be supported, and that the purpose of indicating the priority device state is to indicate the information that should be displayed instantaneously on the display components of the indicated physical conformation.

The identity of an MCD array where at least two among SCDs and MCDs are assembled may be expressed as “MI.C.2.1.ca1, ca2, ca3 . . . can.f1, f2, f3 . . . fzz, FG.D.t1, t2, t3 . . . tn” where “B” may denote an MCD array, “2” may denote the presence of detachable components, “1” may denote that the MCD array is currently being used with no components detached, “ca1, ca2, ca3 . . . can” may be descriptive of the MCD array's inventoried capabilities, “f1, f2, f3 . . . fzz” may be descriptive of the MCD array's inventoried functions, and “FG” may indicate that the following statements present the MCD array's Functional Goal. Subsequently within the same notation, “D” may indicate that the Functional Goal is one embodied in existing functional templates, and “t1, t2, t3 . . . tn” may indicate the specific FG template being used. Such Functional Goal templates may be developed either through “Wild” methods or through, for example, a professional or industry entity or committee empowered to designate such FG templates. In MCD array MIs expressed as “MI.C.2.1 . . . etc.” all components within the MCD array may have some physical connection to the MCD array. MCD arrays being used being used with at least one component physically detached and not physically wired to the MCD array may be expressed as ““MI.C.2.2 . . . etc.”

MCD arrays may be assigned Functional Goals that are not taken from existing templates. Such MCD arrays receiving Functional Goals not taken from a designated template may have an MI expressed as “MI.C.2.[1 or 2].c1, c2, c3 . . . cn.f1, f2, f3 . . . fzz, FG.U.free instruction” where “U” denotes a previously undefined or non-templated Functional Goal statement and “free instruction” indicates that the Functional Goal may be stated in the appropriate terms that may be understood and employed by the MCD array, in a computer language, such as, for example, SGML, according to OOP, or other means of instruction, including “plain English,” which may be interpreted by the MCD array.

In one embodiment each Mobile Identity may have an embedded “Quantum Encrypted Serial ID” (“QESI”), an encrypted serial number generated by the MCD either randomly or on a random short lease from a Library CPU, which may be a record-keeper of log files, device and conformation definitions, FG definitions, and a library of available QESI expressions. The QESI may be a unique identifier for each individual SCD or MCD, tagged to the respective SCD's or MCD's “Cloud Repository.” Such a Cloud Repository may include the MI and may be the active agent requisitioning content and functional services for the physical conformation and persistent states of the MCD or MCD array. In another embodiment MCD arrays may acquire a unique QESI that may be tagged to the MCD array's Cloud Repository so long as the MCD array remains in operation. In another embodiment the MCD array may have its architecture preserved so that it may “re-awaken” if the MCD array's components are reassembled. Such re-awakening may be either automatic or prompted, according to the preferences of the MCD array's user or users or programmed parameters.

The persistent states available within an MCD's Mobile identity may include telephony, multiple still or video camera sessions, small format tablet/e-reader, medium format tablet/e-reader; netbook, laptop, ultrabook, large format e-reader, graphic display, or HD video screen.

The physical conformations available within an MCD's Mobile Identity may include in the first configuration PDA and administrative functions and 3.5″ diagonal browsing mode; in the next configuration may include tablet computing capabilities, including dedicated e-reader and full GUI and graphic functions, and front and back dual surface tablet functions; in the next configuration laptop functions, with a touch or physical keyboard below a separate display screen; or vertically in the same physical configuration as laptop functions, large display e-reader functionality permitting the user to page through full size, facing pages such as, for example, those pages that appear in glossy magazines which stress visual presentation such as fashion, sports, and architecture or interior design periodicals; in the next configuration large, double tablet functions enabling display of full size newspaper pages when held vertically, architectural drawings when laid flat, large format video display when horizontal, or some other high quality and high resolution graphic display. These examples are for purpose of illustration and the available conformations may be more extensive or may encompass any variety of newly identified capabilities. The user may customize the display that will appear when the device is held horizontally or vertically in any configuration.

The content streams within an MCD's Mobile Identity may include mobile browsing; mobile app usage; telephony whether cell-based, Wi-Fi based, or local cell based; video whether streaming Internet, broadcast channels, cable or satellite, or digital video recording capability or recorded material; audio including video soundtrack, Internet streaming, broadcast or satellite radio channels, audio recording and audio playback; photo streaming or file streaming; secure, encrypted information transmission via secure channels such as VPNs; as well as any other form of content or content stream. Where video content may be available through more than one delivery format, the MCD may choose the superior signal or resolution.

In one embodiment the user of an MCD may choose to read an eBook. Such eBooks may be displayed solely through the presentation of content on the reader side, facing the user, or may add display of additional content such as, for example, the book cover, on additionally available display surfaces which may in one embodiment be the rear, outward facing side of the tablet, resembling the traditional outward display of the cover of a physical paper book. Within such embodiments eBooks may be capable of being commercially marketed at more than one price tier, with, for example, a discount offered to the purchaser of the eBook if they agree to display the cover of the book on the outward facing side of the tablet while the content is being read or as a persistent advertisement whose display is not tied directly to when the eBook itself is being read. Such capability of being marketed in variable digital display modes designed to leverage additional display capabilities of multi-display tablets or MCDs may avail the purchasers of such eBooks of flexible prices based in part on economic efficiencies enabled by the enhanced capabilities of MCDs, including but not limited to restoration of ambient marketing capability through book cover display that publishers lost when eBooks came to be read on one-sided tablets and e-readers with no rear display capabilities.

Persistent states may be inventoried through the logging of CPUs in active mode within an individual MCD. These states may be recorded to an MI log file at n intervals per second. Requirements of the various persistent states may thereby be packaged at n intervals per second, tagged with the MI's QESI and shared with the MI's Cloud Repository. The MI's container of requirements may be transmitted upstream via all forms of active connection, including wired and wireless connection modes. As the recipient of the MI log files tasked with supporting the continual variable content and functional requirements “x” of the device(s) (SCD, MCD, MCD ARRAY), the MI's Cloud Repository becomes an individuated digital cloud entity that receives, stores, parses, and fulfills x requirements of the MI, and which actively requisitions content and functional capabilities and operations at n intervals per second from cloud and network resources, then packages x content and functional components and continually transmits variable fulfillment packets of data and functional capability to the MCD. Rather than a series of requests from the MCD to the various content and functional servers providing the components to fulfill the MCD's x requirements, the MI packages its x requirements to provide continually updated and continually variable requisitions for those information components that must be transmitted from the Cloud Repository to the MCD, while releasing calls for those information components that are not required.

To accommodate a history-keeping function there may be a “Library CPU,” a CPU or CPU core devoted to storing log files, array FG templates, QESIs, all components underlying MI identification, declaration, and fulfillment. Such Library CPUs may also retrieve, store, and buffer some or all of the content available for some or all device states for all levels of content quality. For example, many web pages are offered in two forms, a “desktop” page designed to be viewed on a large screen, and a simplified “mobile” page designed to be viewed on a smaller, mobile browsing screen which cannot efficiently display the full web page or its interactive functionality. Web servers typically store documents in a directory tree rooted at a configured directory known as the “document root”. Visitors to web sites will type in a URL, or Universal Resource Locator string, to reach a particular web site. Within the URL, a Universal Resource Identifier or URI comes after the hostname, and provides a relative path from the document root toward the appropriate file or directory. Site administrators may employ a “redirect directive” to divert certain visitors who meet the criteria for the redirection toward another, more suitable URL. In actual effect, the web server is telling the browser to find the page at a different location. Such a redirect process may be invisible to the user until they arrive at the alternate URL with its alternate page. In this example, visitors to the document root who are using a mobile browser may be redirected from the main html page to an alternative URL, where they may access the simplified mobile version of the page. In this case, the mobile visitor will have been steered to the mobile version of the page as a result of the device and browser being used. In order to view the html version, the mobile visitor would, at a minimum, have to refresh the page, and may yet be redirected back toward the mobile version.

It may be seen that such “single form” page serving and associated redirection may present an inefficiency to users of MCDs, who may access a URL via a mobile browser with a device fully enabled to view the desktop version, yet be continually redirected to the mobile version, and be required to take additional action to ensure that they may be able to interact with any content or function set with all the capabilities of their MCD.

In one embodiment of the present invention, therefore, all available forms of content and function sets available at a web domain, URL, web document root or other location or distribution means may be presented at all times to all visitors, such that the Cloud Repository and the Library CPU will have obtained and may maintain all forms of the information, so that a user wishing to look at a different version of a page that is being viewed or has been viewed will be able to retrieve it instantly from the data that has already been retrieved and received. Such enhanced or expanded delivery of all available versions of any content or function sets may be seen as a “digital augmentation” process designed to maximize the benefits of the enhanced capabilities availed to the user by MCDs and MCD Arrays.

The Library CPU may be seen as an onboard server, simultaneously a client recipient of information from the Cloud Repository's server function but server to the potential, designated, or persistent states of the MCD. In one embodiment of the present invention users of MCDs or MCD arrays may switch instantly between such mobile, desktop, or other forms of content and function versions instantly upon reconfiguration to any available form or function of their device, without limitation as to frequency of such reconfigurations per incidence of content or function retrieved, and without loss of performance inherent to any of the available configurations. In one example, an MCD user who has received the mobile version of a web page may be able to retrieve the desktop version instantly, rather than returning to the mobile form or executing a manual redirect from the mobile form to access the alternative version, and to be able to retrieve the alternate version from their browsing history. In this example, a page viewed previously in mobile version may be retrievable in html form from such browsing history without needing to first recall the mobile form, and the MCD user may thereby access the mobile version, for example, when using their MCD configured as a smartphone, with the ability to instantly display the desktop version upon reconfiguration to a tablet or laptop or other large format configuration and interface, without sending an additional content or function request or executing an additional refresh.

For illustrative purposes of this application, the recipe of information requirements that may be requisitioned by the MI's Cloud Repository may be drawn from any of an initial set of, for example, seven base quantum components, and may include any of an initial set of, for example, seven forms of information, though seven is not a limit and the systems and methods described herein may feasibly be extended to n quantum components and n forms of information. Requisition may be made for those functions that are either active persistent states aboard the MCD or are designated default states that must receive information at all times. The MI's packaged requirements may not requisition information for sleeping quantum functions, which status may be a default status or customizable by the user. Required information streams may be transmitted in parallel in their native format to the MCD, as enhanced pursuant to the digital augmentation disclosed above. Information streams that are not actively requested may not be transmitted. The MCD's Cloud Repository may log all events, persistent states, content requisitions, and functions and services.

In another embodiment, the various content streams may be encoded into a uniform protocol, packaged, and transmitted as a single stream to the MCD, which may be optimized to read the encoded components of the single stream and deliver them to the persistent states that have made the information requisitions. This expanded digital packet and or pipe may optimize bandwidth usage and transmission speed by embedding all the downstream requirements of the Mobile Identity in a single upstream requisition.

As MCDs and MCD arrays form and re-form multiple identities, the exchange of information between digital entities may migrate into the varied devices intrinsic to the MCD itself, with all capabilities simultaneously maintained with full efficiency and instantly available or with certain functions requesting certain information at designated times, or as designated by the user on the device, in a pre-existing configuration file, or remotely.

The combination of physical conformation and persistent device states for any MCD may be potentially random entering any moment, but may be queried at n intervals and digitally replicated with a routine frequency upstream in the cloud and in the Cloud Repository, where required information and functional services may be sourced and packaged efficiently and served to all desired or persistent states in each potentially random hardware configuration.

The information and processing requirements of the MCD may change from one moment to another, and do so multiple times, while maintaining all device states simultaneously, or only a subset of device states, and with a different device state in priority at any given time. For this reason it may be beneficial that browsing on an MCD may default to always calling up all possible forms of a web page pursuant to the digital augmentation process described above.

Current languages and protocols deliver data in multiple layers but may not query or expect to receive changes in the physical configuration or default appetites of a client device with n frequency. Their local or served responses may correspond with a single known device that may have multiple and variable simultaneous requirements, but not a varying apparent functional set or varying physical configuration with each configuration associated with a differentiable set of display and functional capabilities. In an MCD environment, there may be both content changes, and content display and quality escalations, that are dependent on MI or that are triggered by changes in physical conformation or persistent device states, with their multiple requirements.

Servers now either ask or receive notification in answer to “who are you,” and may deliver a specific content form in response. MCD clients may be multi-tasking all basic functions or some subset or superset of potential display or functional capabilities selected by the user. As opposed to switching between applications, this may include switching between potential device functions dependent on the physical configuration, in particular with regard to default functions. For example, an MCD that may be used to provide streaming video may have multiple cameras available in laptop configuration but may have only one camera available or optimally positioned to function when in PDA configuration. Such an MCD may continue to provide live streaming video as it is transitioned from one physical conformation to another, and may recognize those cameras that may remain in operation and those that may not, and place the non-functioning elements in sleep mode automatically. Such an MCD may similarly employ or re-awaken the more than one camera if the transition being made is from PDA mode to an expanded mode where more cameras may be available or may be optimally positioned to initiate or resume function or operation. Such changes may be seen holistically as occurring between device scale and function, rather than between applications or between cameras.

MCDs and MCD arrays may present to the network in a multiplicity of identities, and go back and forth between these identities. The network interface and communications will preferably remain continuous and transmissions may preferably remain simultaneous to all identities and persistent states, with display on the MCD or MCD array varying according to the priority persistent device state unless such changes are overridden by the user or users. By illustration, currently, a phone might receive a phone signal, and the browser may receive a mobile network and/or local Wi-Fi signal, and a television may receive an over the air or hardwire network- or broadcast-delivered video stream. It may be seen that none of these transmissions may necessarily accommodate all functions simultaneously. The need to do so while providing instant access without deteriorated performance across all desired functions carries implications for the encoding layer, the transmission layer, and the application layer. In one embodiment the MCD or MCD array may benefit from the coherent delivery of potentially random combinations of content streams through a stable unified transmission pipeline to enable instant access to many forms of the same content without requiring the requisition to be re-sent to the content server or servers, or without requiring multiple parallel requisitions to be re-sent to the content server or servers.

In this example, devices may be seen as continually declaring, acquiring or re-acquiring identities as digital entities or presences. A Cloud Repository may embed many of the potential roles of phone, e-reader, computer, content viewer, content provider, information processor, or digital function executor, being declared, requested or requisitioned by a specific device. The role packaging may happen upstream within the processing capability resources offered by the cloud, with the Cloud Repository drawing what it needs from cloud-based or cloud-resident resources and then transmitting the content down to the device via an MCD Cloud Entity Protocol (“MCDCEP”), with each stream potentially unique in form as well as content.

The roles packaged within each Cloud repository may consist of all default states for the device, or only those actively called, as determined by the user. Given the potential for the same content to be viewed in different forms and capacities on a reconfigurable MCD, the MCDCEP may embed digital augmentation and expansion or augmentation of functions as compressed layers on top of a base layer, as well as embedding a multiplicity of potential or simultaneous states. The additional processing power needed to fetch multiple states of the same content pursuant to the expanded base content assumptions of digital augmentation may be accessed through the enhanced processing capabilities available through and deliverable via the cloud, decreasing the demands on an MCD's CPUs to make multiple requests among potentially multiple transmission channels, or multiple sequential requests along an MCDCEP channel.

Currently, with respect to web browsing, an SCD may declare to the network that it is a mobile device, and be served a mobile web page with an “m” prefix, though it may have the capacity to view the same web page in html format with a “www” prefix.” In this current example, to go from the “m” version of the web page to the “www” version, the SCD must refresh the web page by re-sending the request to the server. MCDCEP may preferably equip both SCDs and MCDs to swap instantly, and to go back and forth, between these two potential views of essentially the same content. As a result of its ability to be physically reconfigured, an MCD may be expanded from a PDA emulation to a laptop emulation. Continuing with this example, when the MCD display is expanded, the display may move from mobile view to full browser view and function virtually instantly, with no need to refresh the web page, and may move back to mobile view similarly instantly with n frequency. MCDCEP may embed the delivery of all content and function sets as provided via, for example, web pages, in all displayable forms whenever any one form of the page is requested.

Persistent states may be further grouped according to their common functional capabilities. “Digital Device Computing Entities” (“DDCEs”) may encompass all forms of computer interfaces including laptop, varied sizes of tablet conformations that may include front and back or multiple displays, and conformations where the display size and interface are comparable to a desktop PC. Such desktop PC embodiments may be supplemented by detachable portions of the MCD that may, for example, emulate detached keyboards or detached mouse interfaces. Digital Computing Entities may also beneficially be equipped to operate with additional interfaces including normal spectrum and infrared motion detection, proximity detection, ultrasound, voice recognition, touch, keyboard, stylus of other interface device, and any other method that may be used to interface with computer processors. Digital Content Creating Entities (DCCEs”) may incorporate PDAs, tablets, laptops, e-readers, large desktop scale displays, still and video camera functions, and MCD arrays providing larger, more efficient, or more powerful versions of each of these conformations. Digital Messaging and Communication Entities (“DMCEs”) may include email, text, multimedia messaging, chat, video chat, telephone functions, and any other means or modes of communication between individuals or entities.

Such DDCEs, DCCEs, and DMCEs will similarly require or benefit from the creation of computer languages and protocols that may be designed to serve continually changing MIs by embedding additional layers of data so that such data layers are may instantly be called upon a change in configuration or orientation of an MCD, as determined by a sensor such as a gyroscope, accelerometer or other form of measurement of an MCD's physical position and orientation, or proximity sensors that may determine the MCD's relative position with respect to the user. Such position, relative position and orientation capabilities are known to those skilled in the art.

For example, a two-sided, single layer tablet configuration could be opened to a four sided laptop configuration, then folded flat to newspaper or open magazine configuration, and may automatically populate with the requisite content according to system defaults, user preferences, and internal proximity and orientation sensors including gyroscopes and accelerometers, and may incorporate multiple such sensors and accelerometers to maintain active and continual self-recognition of self-referential physical configuration. For example, if held vertically in an expanded configuration with the with the long dimension vertical and the vertex of unfolding horizontal, the MCD could default to populate with the content and display functions of a newspaper or periodical, including display of content and interactivity that may include interactive advertisements. If expanded to a large format and with the long dimension horizontal and the vertex of unfolding vertical, the MCD could display video, or may display video on one portion of the surface oriented toward the user and a second content or function set on the other surface oriented toward the user, and be instantly interchangeable between the vertical periodical emulation and the horizontal video emulation with the simple act of reorientation. If laid flat then the newspaper or video functions may be determined by onboard proximity sensors detecting the orientation of the long dimension relative to the position of the of the user with respect to the device.

Furthermore, proximity and face detection sensors may determine that certain display surfaces are oriented away from the user, and may enter sleep mode or take on other function not related to interaction or manipulation by the user, such as, for example, the display of a book cover or virtual movie poster related to the periodical, book, or video content being consumed by the user, for which the user may have received a discount on the content purchase for displaying, or for which the user may receive a fee for displaying.

In one embodiment such non-user oriented surfaces may utilize facial detection and recognition sensors to determine that persons other than the user may be viewing the exterior screens, and may further determine that such persons are members of the user's family, or otherwise known to the user, and may display content or function pursuant to such recognition. In one embodiment the non-user oriented display surface or surfaces may display alternate periodical or alternate video for another known person, or the same periodical or video content for the other known person, with the ability to serve or pause or repeat or refresh such display independently from the viewing of the same periodical or video content by the user on the surfaces oriented toward that user.

Another example of display on the non-user oriented surfaces of the MCD may add a process whereby recognition of location is added to self-recognition of relative configuration and orientation within the MCD, orientation in space, and orientation with respect to the user, or with respect to persons known or unknown to the user. In one embodiment, the MCD may recognize that the location is a public hotspot such as, for example, a Starbucks coffee shop, and may then present advertisements based on discounts received by the user or fees paid to the user where the advertising agreement may call for such advertisements to be displayed within a Starbucks or other public hotspot, which arrangement may include an agreement between the user and the particular hotspot or corporation owning or controlling the hotspot to display advertising served by the hotspot, or served centrally by a corporation, publisher, or other agency to be displayed in such hotspot, pursuant to the rules of permitted content displays in such hotspot.

In another example the MCD may declare its location in the hotspot for fee purposes in order to offer its non-user, or outward-oriented display surfaces to display content generated by the hotspot, cellular carrier, or online company or advertising or other corporate entity. In one embodiment such content may be advertising targeted toward other persons who may be known or unknown to the user, based on the other persons' own disclosure of their presence in the hotspot, and the technical capability of the hotspot and the Cloud Repository to act as agent to serve advertisements targeted toward that other person's interests according to the model practiced in online behavioral advertising, where individuals are targeted by advertisements based on their known interests and purchases. Such third party advertising may preferably not be recorded by the MCD, such that the privacy of the other users served by the utilization of the MCD's non-user oriented surfaces as a third party advertising display would not generate private information that may be recorded or utilized by the MCD user or be otherwise retained by the Library CPU or Cloud Repository.

Similarly to the way that all distributed versions of a particular content may be collectively delivered when any one form of the content is queried by an MCD within the MCDCEP, functional capabilities to manipulate certain content and data may also be delivered collectively and may be accessed and/or swapped to or from instantly, without deterioration in functional performance. The user interface of the MCD may express the desired information including content and functional sets according to the demands or preferences of the user, or according to an initial set of defaults. For example, still photos or video taken in PDA emulation may be presented instantly for editing if the MCD is reconfigured into a tablet or laptop mode, but remain stored rather than presented for editing if PDA emulation is maintained. One reason to present such newly taken photos or video for content upon reconfiguration to laptop or tablet configuration may be the laptop or tablet's capability to present a superior interface for advanced editing of such photos, video, or other content.

In another embodiment the MCD may default to the most advanced version of a particular app dependent on the physical configuration, so that a PDA display of an article from a mobile web site may default to the same information as it was presented in a full magazine page format as, for example, on a tablet. In this example the MCD will take advantage of the higher level of interface capabilities that may be found in a tablet or laptop configuration of the same app, in comparison to the limitations of the PDA emulation. Notably in this example, MCDs may have a powerful onboard file sharing capability and enhanced CPU processing power that leveraging their larger display format may provide access to advanced functions that would be superior to the advanced functions that may be offered on the most advanced SCD smartphones capable of taking the photos and video but unable to provide the larger display interface due to their limitation as, for example, a smaller smartphone that may not be reconfigured to provide a larger display surface.

In another embodiment changing the conformation of the MCD may permit the escalation from lower resolution to higher resolution images, or lower resolution video to higher definition video, and may maintain all potential choices for any reconfiguration of either an active use or a desired persistent use. For example, the book, newspaper, TV, browser, and phone functions and states could all be resident, along with cameras and photoprocessors, etc., so that in addition to advertisements that escalated from banners to graphics, a user could set a default at each configuration stage for the content to be displayed. For example, the user may choose as a default for a magazine-style periodical to go from a single page display to displaying two pages when the display is expanded, while maintaining a newspaper periodical function or TV function in the background that may be swapped to instantly within that same configuration based on a change in device orientation in space or with respect to the user. The user may set a custom default, while retaining access to other options and choices. In the event of a new device configuration created by a new combination, the device identity may have the capability to request content for its newly established distinct needs.

Where MCDs are not necessarily joined in array but may be joined via a local network, various forms of local clouds may be established. In one embodiment the local cloud consists solely of devices with Mobile Identities. Such clouds may be defined as homogenous, expressed as “LC.a.” In another embodiment the local cloud may include other digital entities that do not have Mobile Identities but rather have a Fixed Identity (“FI”).

FIs may be used to identify non-mobile digital devices with substantially a single set of physical conformations and functions, for example household appliances, desktop computers, computer peripherals, televisions, monitoring equipment, home health care equipment, or any other non-mobile digitally enabled entity or form. Such non-mobile devices may be seen as Single Function Devices (“SFDs”), which share with SCD's that they may be used in a single configuration only.

The identity of an appliance with no detachable components may be expressed as “FI.A.1.0.ap1, ap2, ap3 . . . apn,” where “A” may denote an appliance, “1” may denote a single physical unit, “0” may denote no detachable components, and “ap1, ap2, ap3 . . . apn” may be descriptive of the appliance type. The identity of an appliance with detachable components such as, for example, a remote control, may be expressed as “FI.A.1.1.ap1, ap2, ap3 . . . apn,” where “A” may denote an appliance, “1” may denote a single physical unit, “1” may denote a detachable component, and “ap1, ap2, ap3 . . . apn” may be descriptive of the appliance type.

The FI of a non-mobile computer, computer peripheral, router, switch, or other computer-related device with no detachable components device such as a or smart gaming device, may be expressed as “FI.C.1.0.co1, co2, co3 . . . con,” where “C” may denote a computer-related device, “1” may denote a single physical unit, “0” may denote no detachable components, and “co1, co2, co3 . . . con” may be descriptive of the computer-related device type. The FI of a non-mobile computer, computer peripheral, router, switch, or other computer-related device such as a smart gaming device with detachable components, or wireless peripherals, may be expressed as “FI.C.1.1.co1, co2, co3 . . . con,” where “C” may denote a computer-related device, “1” may denote a single physical unit, “1” may denote detachable components, and “co1, co2, co3 . . . con” may be descriptive of the computer-related device type.

The FI of a non-mobile electronic device with no detachable components may be expressed as “FI.E.1.0.el1, el2, el3 . . . eln,” where “C” may denote an electronic device, “1” may denote a single physical unit, “0” may denote no detachable components, and “el1, el2, el3 . . . eln” may be descriptive of the electronic device type. The FI of a non-mobile electronic device with detachable components may be expressed as “FI.E.1.1.el1, el2, el3 . . . eln,” where “C” may denote an electronic device, “1” may denote a single physical unit, “1” may denote detachable components, and “el1, el2, el3 . . . eln” may be descriptive of the electronic device type.

In one embodiment, a Local Cloud where devices with both MIs and FIs are present may be defined as heterogeneous, expressed as “LC.b.” In another embodiment, Local Clouds where only FIs are present may be defined as homogenous, and expressed as LC.c.

In one embodiment, the detached component of an SFD with an FI present in a local cloud LC.b may be a remote control. In such embodiments an MCD or SCD that is also a member of the LC.b may be able to perform at least the same functions as the remote control to operate or control the SFD with an FI. In another embodiment the MCD or SCD may have the capability to supersede or to eliminate access by the remote control to its SFD. This may have the beneficial effect of permitting the administrator of a local cloud LC.b to exert a greater control over the usage of FI devices than is currently practicable within a home network, such as may be desired by a parent in order to control the content being accessed within a home network. This may also have the beneficial effect of permitting the MCD or SCD to download the full set of codes to govern any FI device from cloud resident databases.

In another embodiment a local cloud LC.c may be used to govern any device or set of devices where each has an FI individually or as a group, for example, ensuring the capability to confirm that a stove or oven has been shut off, or to enact the shut-off of such stove, oven, or washing machine remotely, or similarly to permit a home HVAC system to be turned on or off remotely by an enabled MCD or SCD, or to send a single global command through the local cloud to shut off all appliances collectively.

Rapid local cloud deployments of content, function, and display capability may occur. Conceptually, SCDs, MCDs, and SFDs in array may enable and facilitate the creation of an infinite variety of instantly deployable, scalable, massively parallel, multifunction, multiconfiguration, multicomponent, digital computing and display embodiments. The computer languages and communications protocols that optimize the potential of such aggregations of capabilities may permit devices to recognize the arrival of other building blocks with which such devices may interact, with potentially unlimited variations on the physical positioning between any two devices, and similarly unlimited potential to form unique aggregate identities, functional combinations, and data measurement, storage, and output capabilities.

Such local clouds may become digital entities unto themselves, and may act to inventory the interdependencies of different digital entities in any grouping to determine the functions and potential combination services that may be offered or performed. Functions and combination services may be inventoried and offered automatically upon contact or other joining event, prompted and confirmed upon contact or other joining event, or only if positively queried upon contact or other joining event.

Such local clouds may recognize devices upon arrival, and may query and inventory capabilities, persistent states, service requests, and services offered, while also inventorying content forms, bandwidth consumption, or any other relevant data, forming a Local Cloud Entity (“LCE”) that may then establish a Cloud Repository utilizing MCDCEP to exploit the advantages in data tracking, sharing, processing and storage that may be available and inherent in the use of a Cloud Repository. Such heterogeneous local cloud function and device and capability formation and interaction with a Cloud Repository may be understood as an LCE technology. In one embodiment, households may utilize such LCE technology to centralize all phone and programming and web information, organizing and balancing the multiple function sets and information requisitions and capabilities and leveraging requests and upstreaming digital allocation to the cloud. In this embodiment the LCE technology facilitates management and maintenance of any form of identity for any form of definable device or cloud entity. Social networks and collaboration technology currently permit virtual communities, and work groups, with shared information assets and collaborative projects. LCE technology may similarly accommodate “social hardware,” the random accumulation of physical and functional embodiments in an array or a local cloud, through intermixed physical or wireless connection, as described in U.S. Pat. No. 7,782,274.

The benefit of social hardware may be its access to enhanced LCE processing power and augmented LCE functionality. One illustrative example may a local array of multiple cameras including devices with multiple cameras, where some of the cameras may be wirelessly linked, and may be elements of an MCD that have been detached to establish multiple camera positions. Such a local camera array may be physically detached but may be wirelessly linked and synchronized. The capability to operate such an array of cameras, which may also include still photo cameras and video cameras, or multiple video streams capable of generating low or high resolution still images, may empower individuals with the multi-camera setup capabilities that have traditionally been the province of film directors, creating a lower cost means to generate digitally synchronized photography or film of the same sequence from multiple perspectives.

MCDs may be capable of multiple physical forms, with multiple simultaneous device states, fluctuating device identities among all potential device states, and expanded native capabilities. They may be able to sustain multiple capability sessions using multiple CPUs, may contain multiple cameras capable of still photography and video. In one embodiment the various cameras on an MCD may be assigned to follow separate independent subjects within their field of view. In another embodiment multiple cameras may be designed to follow a single subject for enhanced clarity and resolution including 3-D imagery, or to photograph the subject with still photography and video simultaneously, or to photograph the same subject with different default settings for lighting, color balance, and other photography metrics. In another embodiment an MCD with face recognition capability may recognize and follow only familiar or designated subjects.

In one embodiment the LCE may be formed by the different digital devices and other entities in a home network, including appliances with digital capabilities. Devices with fixed identities may also join such an LCE, including but not limited to desktops, non-cellular phones, televisions, dishwashers, laptops, tablets, etc., with the goal of providing enhanced digital access to, coordination of, and employment of local hardware function. In one embodiment it may be possible to use your phone to monitor whether a status message has been sent regarding a load of laundry. In this example it may be possible to check the status of a load of laundry being washed in a washing machine that is a member of the LCE by accessing a status report generated by the washing machine, or alternatively, by accessing a camera in the laundry room, or perhaps a camera mounted in the washing machine, to see whether the load has begun, is in process, or is finished, or whether a malfunction has stalled the cycle. Such video monitoring may be made possible for other appliances including ovens, dryers, machines, even pots and pans. A self-monitoring pot may have temperature sensors or other physical sensors to warn of a boil over, or to permit adjustment of the stove to prevent the boiling over from occurring.

The enhanced capabilities of MCDs and MCD arrays to inventory functional capabilities, to leverage parallel processing and cloud processing capabilities, and to share files between device states to take advantage of advanced functional and interface possibilities, may require additional layers of digital security. Many such measures are known, for example, those disclosed in U.S. Patent Application No. 61/328,263, which is herein incorporated by reference in its entirety. These security measures may involve encryption or biometrics.

For example, MCDs or MCD arrays may employ or require biometric security to enable operation. Such biometrics may be required at startup or continually through operating sessions. In one embodiment MCDs may require biometric security verification to be started or to access network functions. Such biometrics may include facial recognition, fingerprint recognition, or recognition of a secure device in the possession of the user, which may be a device in a pocket, on the wrist, or a digitally recognizable object or chip inserted biologically. Such biometric verification may be provided through use of the MCDs camera(s), touchscreen, infrared sensors, optical readers, Bluetooth transmission, or other interface means. The records underlying such biometric security requirements may reside in the Cloud Repository. In another embodiment the MCD may query for biometric confirmation continually, at regular intervals, or at random intervals, for a particular service or operation to continue, but such that a user of the service or operation and provide confirmation passively, such that no additional action must be taken for the service or operation to continue toward completion. A user may have the option to turn off biometric security either locally or remotely, if, for example, user wishes to make a device governed by the LCE operable by other users without such security confirmation. In one embodiment biometric data may be stored aboard the MCD or in the Cloud Repository for more than one authorized user. In another embodiment, only some users may be authorized to make administrative changes to the biometric authorizations. In another embodiment biometric security may be employed to block certain users from performing certain functions.

In one embodiment devices may be set to cease to function if their owner were not within a specific minimum distance, or to remain in some limited form of operation that did not compromise security until the authorized user may return. In another embodiment secured MCDs may act as keys to enable other devices either to be operated, or may control administrative changes to such devices. In one embodiment, home appliances may be prevented from working if their owners are not within a certain distance, or are not present or detectable on a home network. In one embodiment a kitchen or laundry appliance may not be operable unless an authorized adult is within a minimum safe monitoring distance. In another embodiment, an authorized user may join the network from a remote location, and provided that the security verification requirements are satisfied, may provide remote authorization for the security-restricted appliance or other service or device to be operated, or may grant operating rights remotely, or may start the appliance remotely, or may be warned if anyone approaches a security restricted appliance or other device in operation. In one embodiment an authorized person may have the capability also to query about unauthorized operation from a remote location, and to terminate such unauthorized operation even if it has already begun. Such precautions may be beneficial to prevent young children from operating, for example, stoves, ovens, or washing machines.

Use of biometrics and other security measures within LCE technology may permit databases of such authorizations to be maintained upstream of devices, and may also permit passive logging of device or appliance activity, including identity of actors for any logged events or changes in authorizations. The process by which LCE technology may manage device and appliance operation may be seen as superior to surveillance cameras meant to monitor unauthorized activity, in that the LCE technology monitors actions and functions directly related to safety, may generate status reports and alerts, and provides the capability to terminate or mitigate situations where a security-restricted device or appliance may have been operated by an unauthorized user. In addition, the LCE technology's focus on device control and event logging, and its surveillance of digital instructions and operational events may be seen as an effective means to enhance safety with little to no impact on individual privacy, as opposed to a surveillance camera's designated function of generating surveillance footage, which may be seen as more invasive.

The biometric security functions may be applied in various ways to many potential states of an MCD as well as to LCE constituent devices or appliances. An MCD may, for example, be programmed not to activate for a user who cannot provide at least two biometrics among any of fingerprint, retinal, facial recognition, or voice, or any other biometric security measure. Biometric security may be employed in similar fashion for MCD arrays. Through the LCE technology, similar restrictions designed to ensure authorized or safe operation may be put in place for constituent devices and appliances, whereby access to a social hardware structure may be secured with biometrics as an additional option, and capabilities allocated hierarchically according to biometrics.

In one embodiment a security risk may be present that either SCDs or MCDs may eavesdrop on other devices, including other devices in an array, and record or corrupt operation or access to physical configurations, persistent states, technical efficiencies, or local information product, or may otherwise steal content. In this example, an individual MCD or persistent state in an MCD may be seen as potentially functioning in the role of a digital virus. To provide a bather against such corruption or damage, secure encryption may be necessary to operate individual MCDs, or to operate any of the potential device states and CPUs within a single MCD. In one embodiment, the Library CPU and the Cloud Repository in partnership may generate encryption keys with x frequency to protect individual device states and the MCD as a unit, or may use performance metrics tied a proximity sensor aboard the MCD, to ensure that the MCD is not infected by a virus, or hacked or hijacked by unauthorized users.

In one embodiment, minor users in a household may be permitted to surf the Internet but prevented through biometrics from changing their authorization to access blocked Internet sites. Administrators could instantly freeze, block, or undo any unauthorized changes to information access or authorized function within any existing configuration, as well as access how and when the alteration occurred, because the alteration would carry a literal fingerprint. Such security may offer a number of beneficial tools to permit entities including households to use biometric security to control access to and operation of all interface devices and appliances tied into their LCE and its Cloud Repository with. Such device-based and LCE-based security restrictions implemented within a home network and encrypted, stored and tracked by the Cloud Repository may be seen as establishing and managing home safety by creating “HITS,” or “Households in the Sky.”

In one embodiment, in order to optimize power consumption and efficiency of an MCD, an MCD may be equipped to shut off a device state when it detects that it may not function, and to search or to signal the Cloud Repository to identify when the function is possible again. The MCD may further employ local signal strength measurements, or the measured strength of its communication signal with the Cloud Repository, to govern some element of device operation and shut-down. In one embodiment, there may be a local Wi-Fi network available, but the phone signal may not be strong enough to connect to the cellular network. The Cloud Repository may use location monitoring capabilities to identify whether the cell phone is within range of adequate coverage, to sleep the phone function so long as it is out of coverage, and to restore it as it approaches coverage.

In one embodiment the Cloud Repository may generate alerts warning of limitations to optimal functioning of device states. Such alerts may be audible, may be visual alerts using color or light, or may be in the form of SMS text warnings, or these and other alternative alert mechanisms in combination. In one embodiment phone signal strength detection and potential mitigating action by the Cloud Repository may be set to be active only between phone calls, or may be set to provide a distinct audible signal to the user if that a condition that may lead to a dropped call is imminent during a phone call, or appears to be imminent between phone calls. Alternatively, such alerts may be set not to be active at all, or to be active only when the MCD is configured in the physical form of a phone.

In one embodiment device capabilities or persistent states may be enabled to or moved to priority if passively activated. In one embodiment the telephone may be in a default sleep mode until the Cloud Repository detects an incoming telephone call. In this example the Cloud Repository may send the MCD a signal that a telephone call is coming in, and wake up the telephone device state, permitting the telephone call to be received and completed in a manner that is seamless from the standpoint of the user, but which conserved battery power by minimizing cellular transmission time or bandwidth usage when the phone is not being used.

Such detection and validation functions may also be structured to use alternate streams to effectuate a desired persistent state. In the example of a phone call where the signal over the cellular network is too weak, the Cloud repository may re-route the telephone call via Internet telephony through a Wi-Fi network instead to prevent the call being dropped, and may buffer some portion of a telephone call that is at risk of being dropped, in order to aid resumption of the conversation, or to permit one or the other of the parties to the phone conversation to hear what was being said as the call began to deteriorate or was dropped. The Cloud Repository may re-route the telephone call to the cellular network again should its quality return to a level superior to the quality being offered via the Internet telephony routing. In such cases the Cloud Repository may be communicating with the device via a number of available means, whether Wi-Fi, cellular, high speed or lower speed network capabilities, and may cross-allocate any content stream within a persistent state between networks to ensure that function is maintained.

Where all network signals may be unavailable, the MCD and the Cloud Repository may seek each other through available conditions based on last known location, and may activate communication functions optimized to the signal strength that may best serve a particular function.

One beneficial consequence of MCD embodiments and MCD array embodiments may be that their increased capabilities may be used by all forms of entities to achieve increased productivity. For example, businesses may rapidly create modular supercomputing capabilities from standard device conformations and architectures. Similarly, repair of computing, electronic, and other components may be facilitated by MCD arrays that may be conformed with similar capabilities to perform required functions. In other embodiments commercial products may be built using modular arrays of MCDs, permitting repairs to be made with relative simplicity by repair professionals or by individual users alone or in consultation with repair professionals, where the fault in a particular array may be determined to reside in a single MCD within the array.

Another beneficial consequence of such embodiments may be to facilitate the commoditization of computing devices and services. In addition to modular parts constructed from MCDs and simple or complex MCD arrays, MCDs may be manufactured and deliverable as blank slates able to be configured to meet varied device architectures and may be compatible with substantially all available operating systems and communications protocols. In one embodiment, the modularity possible with MCDs may permit manufacturing efficiencies whereby phone device components become standardized without regard to cellular service provider, and a persistent phone capability may thus be portable between various cellular service providers without the need to purchase a new phone.

One beneficial consequence of the technology may be that substantially anything digital may be assembled or functionally emulated using MCDs as building blocks, potentially bringing together manifold technical capabilities including digital processing, orientation and position detection, audio and photo capability, various digital communications technologies, local and cloud-distributed biometric security, and other such technologies that are known and are incorporated by reference.

In some embodiments, an MCD's multiplicity of display capabilities may include touch screens, backlit screens, non-backlit ink screens, and may accommodate multiple input modes including attached, wired, or wireless touch keyboards or mechanical keypads or keyboards, and touchscreen interfaces including finger touch, stylus, optical wand, or other physical interface devices and technologies. In one embodiment, a “smart” stylus may be equipped to recognize and remember drawing movements of handwritten characters, and the MCD may query such smart stylus to improve its ability to recognize handwritten characters written onto its touch screen, and may utilize MCDCEP to automatically back up such data to its Cloud Repository.

In some embodiments infrared, motion detection, or ultrasound technologies plus voice recognition may be employed to permit hands-free operation of the MCD without need of a physical interface device, including manipulation of screen imagery comparable to manipulate digital content via touchscreen swiping, but without making direct contact with the screen. Certain biometric recognition and security metrics may be employed to optimize such hands-free interfaces by a user with an MCD in any physical environment.

In another embodiment, the flexibility of MCD arrays may make it possible for individuals to easily upgrade computing power to take advantage of new software, or to replace aging digital and computer components to take advantage of new hardware capabilities, without having to replace an entire computing device. In one embodiment CPUs may be subsequently enhanced or replaced for each potential function of an MCD to reflect current technology and to prolong the operating life of the MCD. In another embodiment the embedded nature of the Cloud Repository may effectively back up devices at frequent intervals and may make facilitate or expedite replacement of lost devices with new ones with no loss of information. Various persistent device states may be backed up independently according to varied schedules, or maintained as minors on an MCD to a second SCD or SFD. Another beneficial consequence of MCDCEP may be that all data may be backed up at all times by virtue of the Cloud Repository.

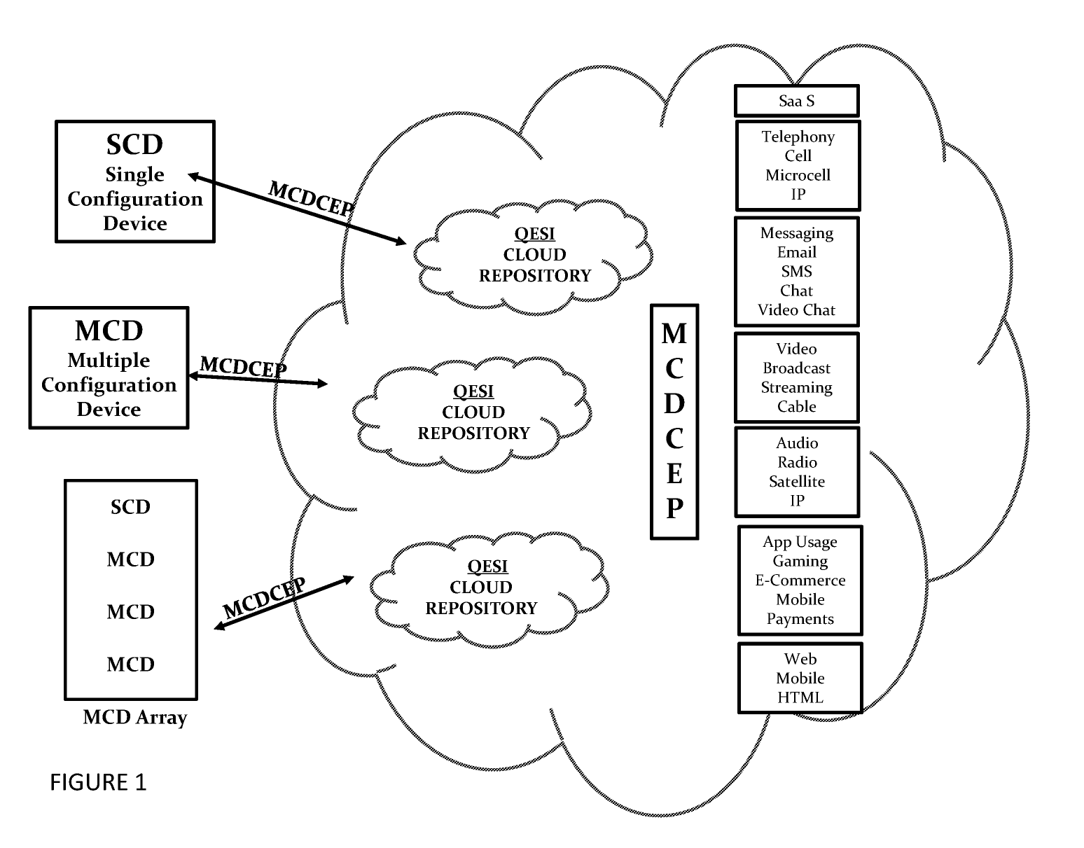

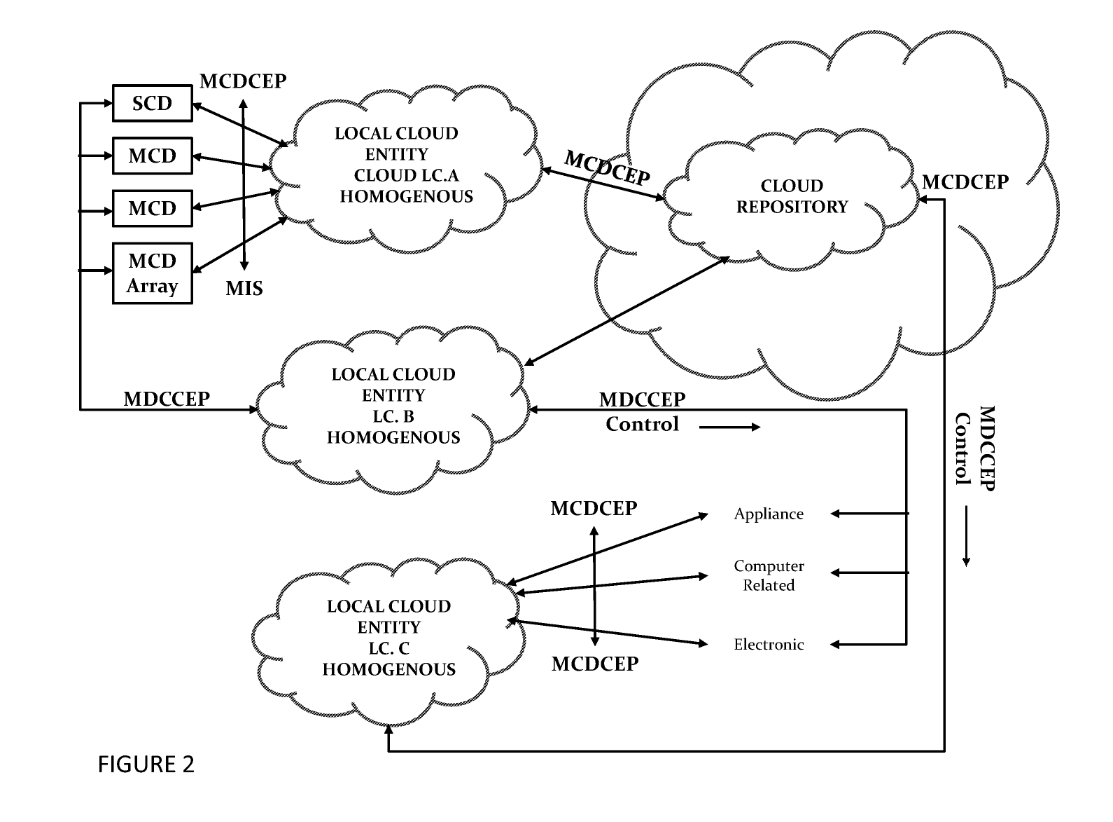

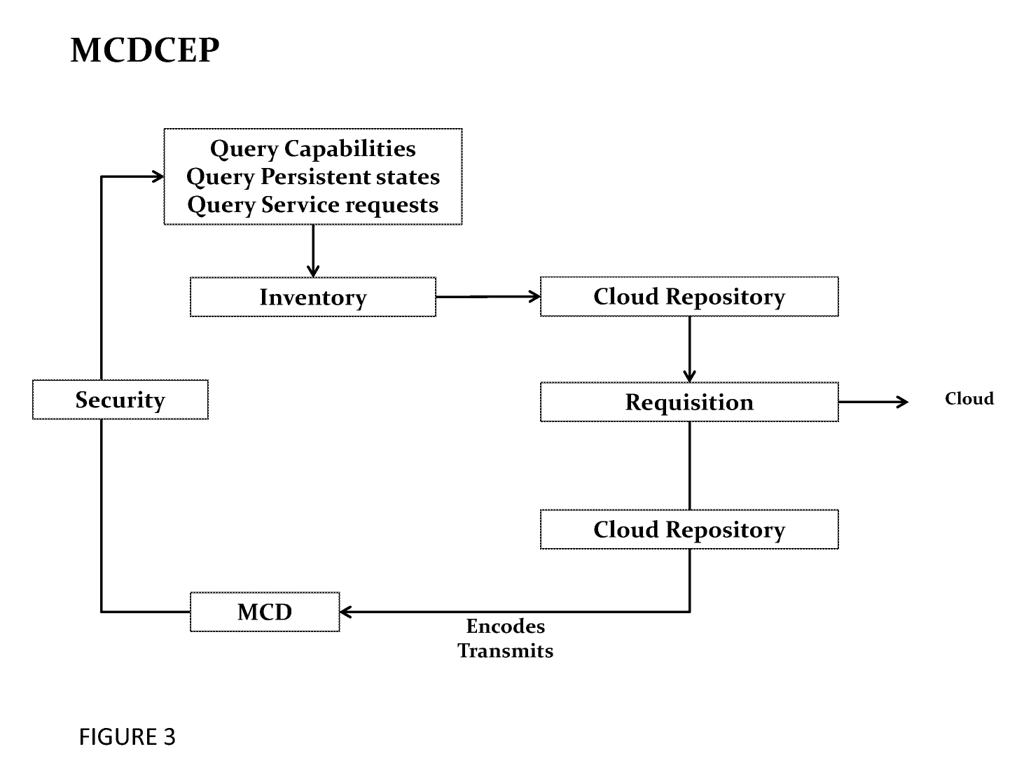

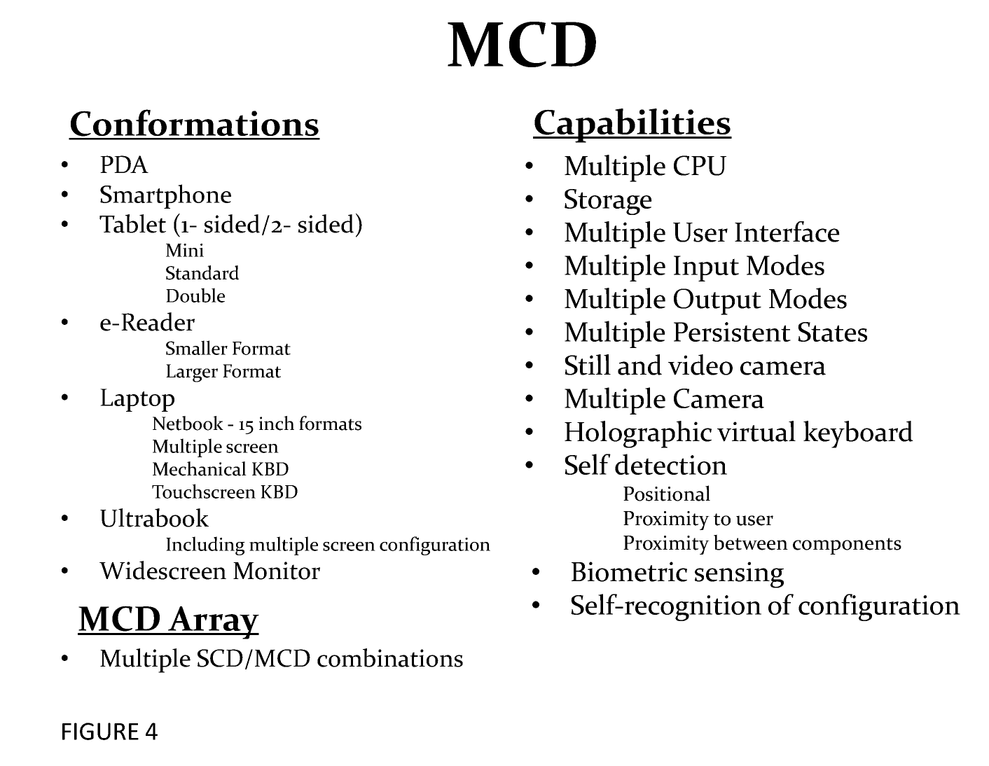

Certain features and embodiments of the present invention are further described in the accompanying figures. FIG. 1 is a high-level schematic of SCDs/MCDs/MCD arrays interfacing with cloud repositories and the cloud. FIG. 2 is a local cloud according to an embodiment of the invention. FIG. 3 is illustrates an embodiment of protocol operation. FIG. 4 lists example MCD capabilities.

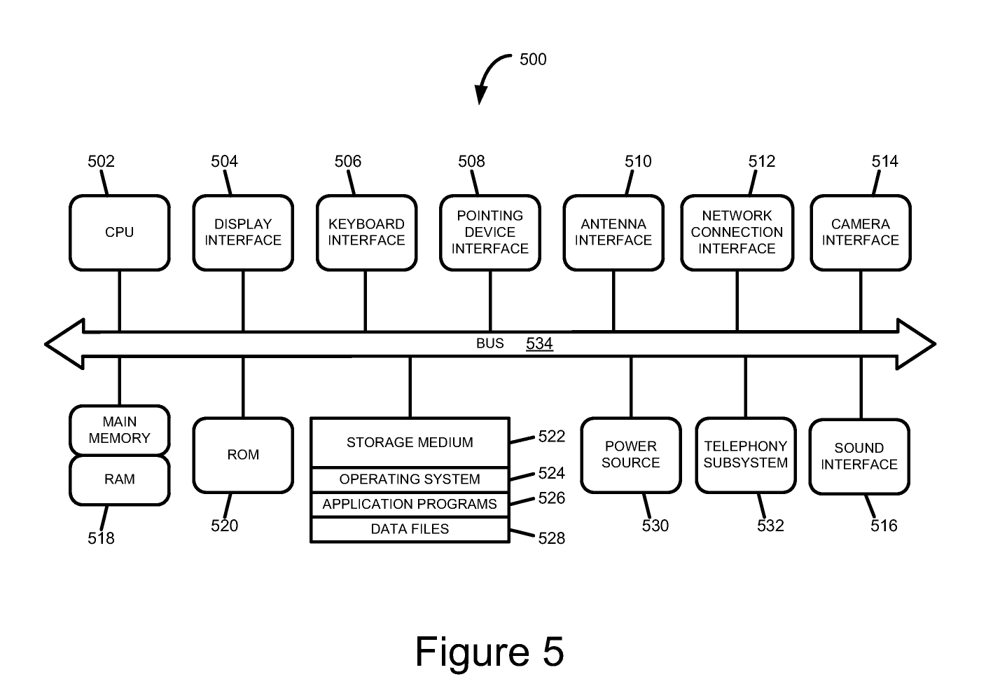

FIG. 5 depicts a block diagram of the architecture of a multiconfiguration device according to an embodiment of the disclosed technology. Certain aspects of FIG. 5 may also be embodied in an external system (for example, a server that processes audio signals received through a distributed network).

Multiconfiguration device 500 includes a central processing unit CPU) 502, where computer instructions are processed; a display interface 504 that acts as a communication interface and provides functions for rendering video, graphics, images, and texts on the display; a keyboard interface 506 that provides a communication interface to a keyboard; and a pointing device interface 508 that provides a communication interface to a pointing device or a presence-sensitive display such as a touch screen. As understood by one skilled in the art, display interface 504, keyboard interface 506, and pointing device interface 508 may be embodied in a single unit, such as a presence-sensitive display or touch screen. The display interface includes a display device. As understood by those skilled in the art, a display device can be any type of component that can display information, such as an LCD screen, LED screen, AMOLED screen, or projector; and, the term display device means one or more display devices. Various embodiments of the methods described herein may be embodied in non-transitory computer readable media, such as storage medium 522, for execution by CPU 502. Embodiments of the multiconfiguration device 500 may include an antenna interface 510 that provides a communication interface to an antenna; a network connection interface 512 that provides a communication interface to a network. In certain embodiments, a camera interface 514 is provided that acts as a communication interface and provides functions for capturing digital images from a camera. In certain embodiments, a sound interface 516 is provided as a communication interface for converting sound into electrical signals using a microphone and for converting electrical signals into sound using a speaker. According to various embodiments, a random access memory (RAM) 518 is provided, where computer instructions and data are stored in a volatile memory device for processing by the CPU 502.

According to an embodiment, the multiconfiguration device 500 includes a read-only memory (ROM) 520 where invariant low-level systems code or data for basic system functions such as basic input and output (I/O), startup, or reception of keystrokes from a keyboard are stored in a non-volatile memory device. According to an embodiment, the multiconfiguration device 500 includes a storage medium 522 or other suitable type of memory (e.g. such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives), where the files include an operating system 524, application programs 526 (including, for example, a web browser application, a widget or gadget engine, and or other applications, as necessary) and data files 528 are stored. According to an embodiment, the multiconfiguration device 500 includes a power source 530 that provides an appropriate alternating current (AC) or direct current (DC) to power components. According to an embodiment, the multiconfiguration device 500 includes and a telephony subsystem 532 that allows the multiconfiguration device 500 to transmit and receive sound over a telephone network. The constituent devices and the CPU 502 communicate with each other over a bus 534.

In accordance with various embodiments, the CPU 502 has appropriate structure to be a computer processor. In one arrangement, the computer CPU 502 is more than one processing unit and/or is a multi-core processor and/or is more than one multi-core processor. The RAM 518 interfaces with the computer bus 534 to provide quick RAM storage to the CPU 502 during the execution of software programs such as the operating system application programs, and device drivers. More specifically, the CPU 502 loads computer-executable process steps from the storage medium 522 or other media into a field of the RAM 518 in order to execute software programs. Data is stored in the RAM 518, where the data is accessed by the computer CPU 502 during execution. In one configuration, the device 500 includes at least 128 MB of RAM, and 256 MB of flash memory.

The storage medium 522 itself may include a number of physical drive units, such as a redundant array of independent disks (RAID), a floppy disk drive, a flash memory, a USB flash drive, an external hard disk drive, thumb drive, pen drive, key drive, a High-Density Digital Versatile Disc (HD-DVD) optical disc drive, an internal hard disk drive, a Blu-Ray optical disc drive, or a Holographic Digital Data Storage (HDDS) optical disc drive, an external mini-dual in-line memory module (DIMM) synchronous dynamic random access memory (SDRAM), or an external micro-DIMM SDRAM. Such computer readable storage media allow the multiconfiguration device 500 to access computer-executable process steps, application programs and the like, stored on removable and non-removable memory media, to off-load data from the multiconfiguration device 500 or to upload data onto the multiconfiguration device 500. A computer program product, such as one utilizing a communication system may be tangibly embodied in storage medium 522, which may comprise a machine-readable storage medium.

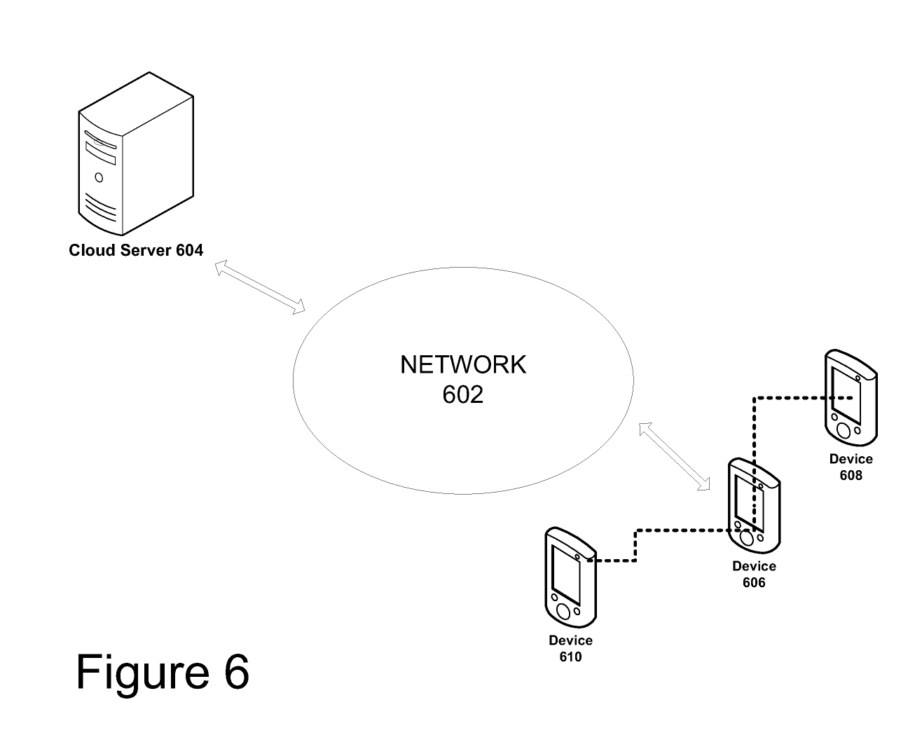

FIG. 6 represents high-level architecture of the present invention in accordance with certain embodiments. In FIG. 6, Device 606, Device 608, and Device 610 are coupled to each other; for example, wirelessly. These devices may be any combination of SCDs or MCDs. It is also understood that while three devices are shown, the present invention contemplates a fewer or greater amount of coupled devices as well. Device 606 is in communication with Cloud Server 604 via Network 602. Device 606 indicates, to Cloud Server 604, that it is coupled into a device array with Device 610 and Device 608. Cloud Server 604 is then able to transmit content or provide services to the device array, based on the device array configuration. Cloud Server 604 is also able to store information associated with the device array; for example, storing a Mobile Identity serial identification associated with the device array.

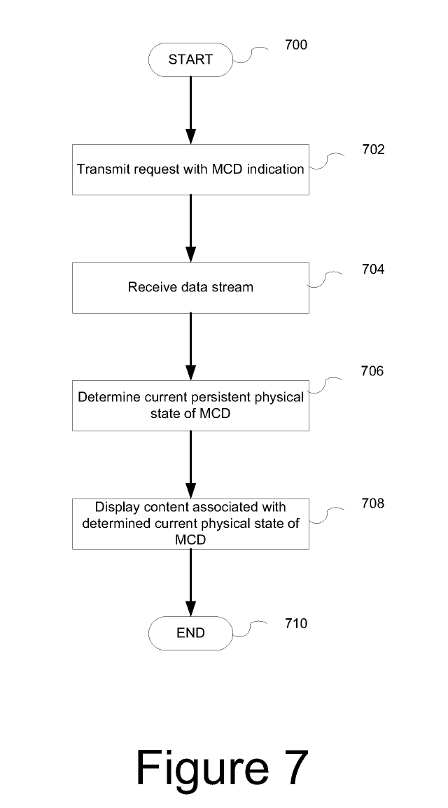

FIG. 7 represents a process flow of the present invention in accordance with certain embodiments. The process flow starts at step 700 and proceeds to step 702, where a request is transmitted, for example through a network connection, and the request includes an indication that the request originated from a MCD. The MCD is operable to be configured into two or more physical forms (or two or more persistent physical states). At step 704, a data stream is received, where the data stream comprises content associated with two or more persistent physical states. The current configuration (or current persistent physical state) of the MCD is determined at step 706. Content that is associated with the determined current persistent physical state of the MCD is displayed at step 708. At step 710, the process ends.

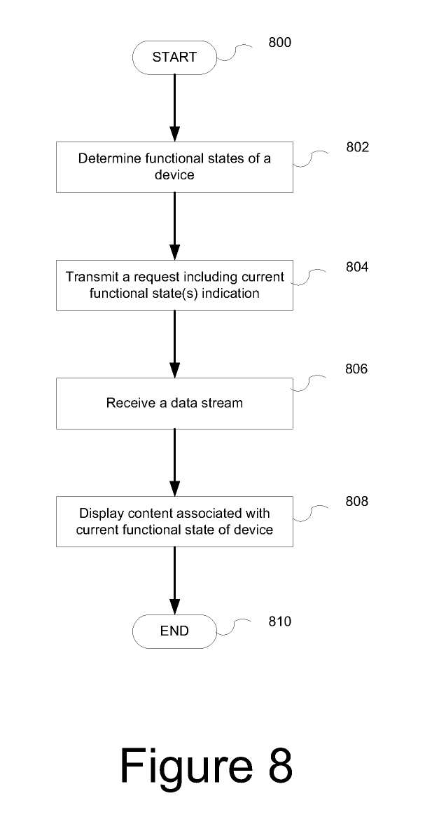

FIG. 8 represents a process flow of the present invention in accordance with certain embodiments. The process flow starts at step 800 and proceeds to step 802 where the functional states of a device are determined. A request is transmitted where the request comprises an indication of one or more of the current functional states of the device, at step 804. A data stream is received, at step 806, where the data stream comprises content associated with the one or more current functional states of the device. At step 808, at least a portion of the content associated with the one or more current functional states of the device is displayed. At step 810, the process ends.

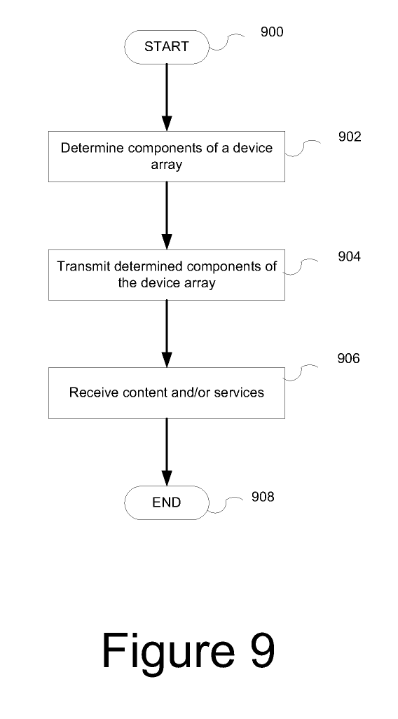

FIG. 9 represents a process flow of the present invention in accordance with certain embodiments. The process flow starts at step 900 and proceeds to step 902, where the components of a device array are determined, for example by a program-controlled computer processor. The device array may be comprised of SCDs, MCDs, or combinations thereof. At step 904, the determined device array, or an indication of the devices that make up the device array, is transmitted. At step 906, content and/or services based on the components of the device array, or a mobile identity serial identification, are received. At step 908, the process ends.

Certain embodiments of the disclosed technology are described above with reference to process flows of systems and methods and/or computer program products according to various embodiments of the disclosed technology. It will be understood that one or more process flows, and combinations of steps in the process flows, respectively, can be implemented by computer-executable program instructions. Likewise, some steps in the process flows may not necessarily need to be performed in the order presented, or may not necessarily need to be performed at all, according to some embodiments of the disclosed technology.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in a process flow. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in a process flow. As an example, embodiments of the disclosed technology may provide for a computer program product, comprising a computer-usable medium having a computer-readable program code or program instructions embodied therein, said computer-readable program code adapted to be executed to implement one or more functions specified in a process flow. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the process flows.

Accordingly, steps of a process flow support combinations of means for performing the specified functions, combinations of elements or steps for performing the specified functions and program instruction means for performing the specified functions. It will also be understood that each step of a process flow, and combinations of steps in the process flows, can be implemented by special-purpose, hardware-based computer systems that perform the specified functions, elements or steps, or combinations of special-purpose hardware and computer instructions.

The foregoing components of the present invention described as making up the various elements of the invention are intended to be illustrative and not restrictive. Many suitable components that would perform the same or similar functions as the components described are intended to be embraced within the scope of the invention. Such other components can include, for example, components developed after the development of the present invention.

The patentable scope of certain embodiments of the disclosed technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A computer-implemented method comprising:
transmitting, via a network connection, a request, wherein said request comprises an indication that said request originated from a multiconfiguration device, said multiconfiguration device operable to be configured into two or more persistent physical states;
receiving, via the network connection, a data stream comprising content associated with two or more persistent physical states;
determining, by a program-controlled computer processor, a current persistent physical state of the multiconfiguration device; and
displaying, via a display device, at least a portion of the content associated with the determined current persistent physical state of the multiconfiguration device.

2. The computer-implemented method of claim 1 wherein said persistent physical states are selected from a group consisting of: telephone, smartphone, camera, single-sided tablet, double-sided tablet, multi-display tablet, e-reader, netbook, laptop, ultrabook, graphic display, and HD video screen.

3. The computer-implemented method of claim 1 wherein said indication that request originated from the multiconfiguration device comprises an identification of two or more potential persistent physical states of the multiconfiguration device.

4. The computer-implemented method of claim 1 wherein a different computer processor or different computer processor core provides processing functionality for each persistent physical state of the multiconfiguration device.

5. A computer-implemented method comprising:
determining, by a program-controlled computer processor, one or more current functional states of a device; and
transmitting, via a network connection, a request, wherein said request comprises an indication of the one or more current functional states of the device;
receiving, via the network connection, a data stream comprising content associated with the one or more current functional states of the device;
displaying, via a display device, at least a portion of the content associated with the one or more current functional states of the device.

6. A computer-implemented method comprising:
determining, by a processor, components of a device array, wherein said device array comprises two or more devices;
transmitting, via a network connection, said determined components of the device array; and
receiving, via the network connection, content and/or services based on the determined components of the device array or a mobile identity serial identification.

7. A computer-implemented method comprising:
receiving, via a network connection, determined components of a device array;
storing, in a non-transitory computer-readable medium, a mobile identity serial identification associated with the determined components of the device array; and
determining, by a program-controlled computer processor, the content to be transmitted and/or services to be provided to the device array, based on the components of the device array and/or the mobile identity serial identification.

8. A computer-implemented method comprising:
receiving, via a network connection, a request, wherein said request comprises an indication that said request originated from a multiconfiguration device, said multiconfiguration device operable to be configured into two or more persistent physical states;
processing, by a program-controlled computer processor, in response to said request, a plurality of content into a data stream, wherein said data stream comprises content associated with two or more persistent physical states; and
transmitting, via the network connection, the data stream to the multiconfiguration device.

9. A computer-implemented method comprising:
receiving, via a network connection, a request, wherein said request comprises an indication of one or more current functional states of a device;
processing, by a program-controlled computer processor, in response to said request, a plurality of content into a data stream, wherein said data stream comprises content associated with the one or more current functional states of the device; and
transmitting, via the network connection, the data stream to the device.

10. A system comprising:
a program-controlled processor configured to:
transmit, via a network connection, a request, wherein said request comprises an indication that said request originated from a multiconfiguration device, said multiconfiguration device operable to be configured into two or more persistent physical states;
receive, via the network connection, a data stream comprising content associated with two or more persistent physical states;
determine a current persistent physical state of the multiconfiguration device; and
display, via a display device, at least a portion of the content associated with the determined current persistent physical state of the multiconfiguration device.

11. The system of claim 10 wherein said persistent physical states are selected from a group consisting of: telephone, smartphone, camera, single-sided tablet, double-sided tablet, multi-display tablet, e-reader, netbook, laptop, ultrabook, graphic display, and HD video screen.

12. The system of claim 10 wherein said indication that request originated from the multiconfiguration device comprises an identification of two or more potential persistent physical states of the multiconfiguration device.

13. The system of claim 10 wherein a different computer processor or different computer processor core provides processing functionality for each persistent physical state of the multiconfiguration device.

14. A non-transitory computer-readable storage medium with an executable program stored thereon, wherein the program instructs a computer processor to perform the following steps:
transmit, via a network connection, a request, wherein said request comprises an indication that said request originated from a multiconfiguration device, said multiconfiguration device operable to be configured into two or more persistent physical states;
receive, via the network connection, a data stream comprising content associated with two or more persistent physical states;
determine, by the computer processor, a current persistent physical state of the multiconfiguration device; and
display, via a display device, at least a portion of the content associated with the determined current persistent physical state of the multiconfiguration device.

15. The non-transitory computer-readable storage medium of claim 14 wherein said persistent physical states are selected from a group consisting of: telephone, smartphone, camera, single-sided tablet, double-sided tablet, multi-display tablet, e-reader, netbook, laptop, ultrabook, graphic display, and HD video screen.

16. The non-transitory computer-readable storage medium of claim 14 wherein said indication that request originated from the multiconfiguration device comprises an identification of two or more potential persistent physical states of the multiconfiguration device.

17. The non-transitory computer-readable storage medium of claim 14 wherein a different computer processor or different computer processor core provides processing functionality for each persistent physical state of the multiconfiguration device.
